(19) United States
(12) Patent Application Publication
(10) Pub. No.: US 2026/0126064 A1
(43) Pub. Date: May 7, 2026

(54) Clamp

(71) Applicant: Brian Goldwitz, WATERBURY, CT (US)

(72) Inventor: Brian Goldwitz, WATERBURY, CT (US)

(21) Appl. No.: 19/311,520

(22) Filed: Aug. 27, 2025

Related U.S. Application Data
(60) Provisional application No. 63/715,493, filed on Nov. 1, 2024.

(51) Int. Cl. F16B 2/10

(52) U.S. Cl. CPC F16B 2/10

(57) ABSTRACT

The current invention is a new design for a clamp. The clamp has a top plate that pushed down to hold the item being clamped such as the lip of a vehicle hardtop, a hinge, a clamp plate and a locking plate. The device can also have a locking handle or a locking pin to lock the clamp in place.

### TECHNICAL FIELD

The technology discussed below relates a clamp and more one that is easier to use with edges

### RELATED APPLICATIONS

This application claims the priority date of Provisional Application 63/715,493 filed on Nov. 1, 2024.

### BACKGROUND

Clamps are defined as a device made of wood or metal that is used to hold two things together tightly.

There are a large number of clamps and while many people who enjoy outdoor activities own sport utility vehicles (SUVs) with hardtops that can be removed in order to give occupants more pleasure while riding in the vehicle. The hardtops, need to be carefully removed, and once removed, need to be stored in appropriate fashion in order to prevent damage to them. As such hardtops are relatively bulky and heavy, such lifting and storage is not an easy task. Laying the hardtops on a ground surface is not satisfactory as that can cause damage to the hardtop, especially to its finish. But currently there are no good clamps that can be used in this function.

There is still room for improvement in the art.

### SUMMARY

The current invention is a new clamp device specially designed to clamp to unique items.

The current invention is a new design for a clamp. The clamp has a top plate that pushed down to hold the item being clamped such as the lip of a vehicle hardtop, a hinge, a clamp plate and a locking plate. The device can also have a locking handle or a locking pin to lock the clamp in place.

These are improvements over the current art.

### BRIEF DESCRIPTION OF THE FIGURES

FIG. 1 is a display of a prior art clamp.

FIG. 2 shows a side view of the clamp.

FIG. 3 shows a front view of the clamp.

FIG. 4 displays the clamp with its locking plate in an unlocked position.

FIG. 5 displays the clamp with its locking plate in a locked position.

FIG. 6 displays a clamp attached to the hardtop.

FIG. 7 shows a side view of the clamp attached to the hardtop.

FIG. 8 displays a clamp attached to the hardtop with a locking bolt being placed.

FIG. 9 displays a clamp attached to the hardtop with a locking bolt in the locking position.

FIG. 10 shows clamps attached to a rim.

FIG. 11 shows the clamp unattached.

FIG. 12 shows clamps hanging from a frame.

FIG. 13 shows clamps with a hooked end.

FIG. 14 shows a side view of the clamp with a hooked end.

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

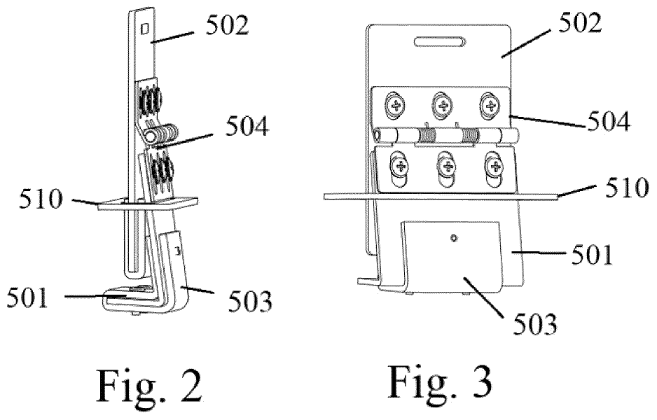

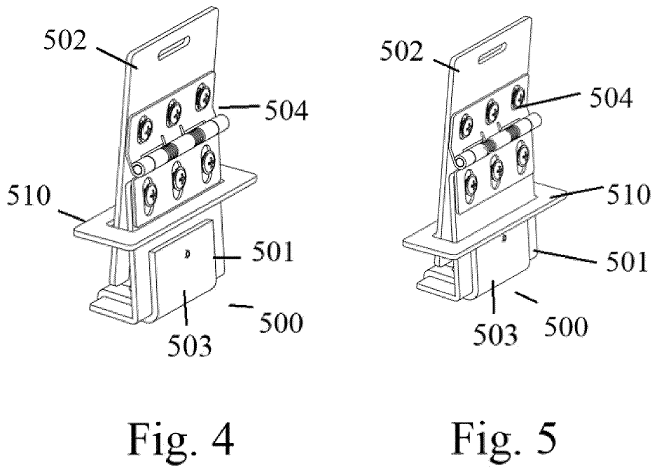

FIGS. 2 through 12 shows the current invention is a new design for a clamp 1. The clamp 1 has a top plate 502 that pushed down to hold the item 200 being clamped such as the lip of a vehicle hardtop, a hinge 504, a clamp plate 501 and a locking plate 510.

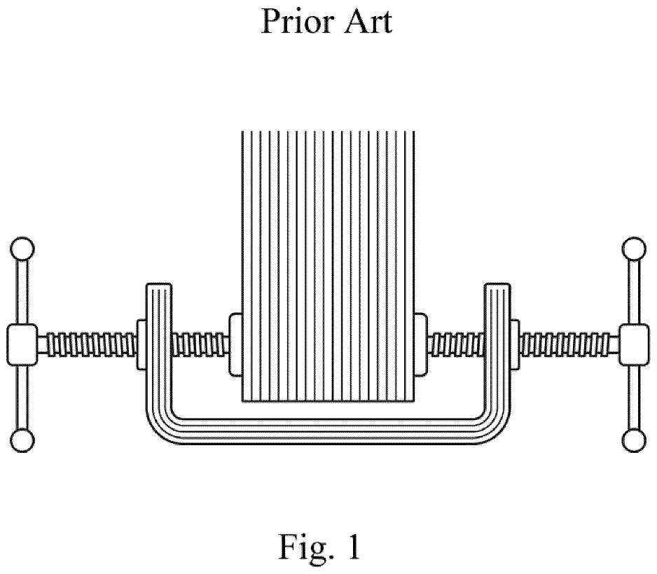

FIG. 1 shows a prior art clamp. A clamp with a frame, handle, collar, fixed jaw, movable jaw and screw. While it is very versatile, it is not usable or practical for all situations. Especially when you are trying to clamp an item 200 that has a lip.

FIGS. 2 through 6 shows an embodiment of the device 1 which is for a specialized clamp 1.

The device 1 has a top plate 502 that pushed down to hold the item 200 being clamped such as the lip of a vehicle hardtop, a hinge or flexible connector 504, a clamp plate 501 and a locking plate 510. The device can also have a locking handle 525 or a locking pin 575 to lock the clamp in place. The size of the clamp 500 depends on the need of the user and the item 200 being clamped.

In the preferred embodiment, the top plate 502 is in a flat rectangular shape with a curved bottom that curves behind it forming a broader surface to exsert force on the item being held. It may have a strap opening at the top where a strap or cable or belt can be attached allowing the clamp 1 to be secured, hung or moved by a strap 400.

The clamp plate 501 is a flat rectangular shape that bends forward at 90 degree to form a pressure surface on which the item 200 being held can rest on. The clamp plate 501 can have a clamp plate cover 503 which is made of a soft surface like rubber to cushion and protect the item 200 being held.

The clamp plate 501 and the top plate 503 are attached by a hinge 504 forming a flexible connection. Other connectors can be used such as a rubber connection or other similar material. The hinge 504 can be connected to the clamp plate 501 and the top plate 503 by screws or welding or an adhesive.

The locking plate 510 is a flat rectangular with a rounded opening in the center. The clamp plate 501 and the top plate 503 are positioned within the opening. When the locking plate 510 is pushed down it moves the top plate 503 down and in towards the pressure surface of the clamp plate 501 by pivoting on the hinge 504 holding the idem in place. The locking plate 510 is moved up for release the idem.

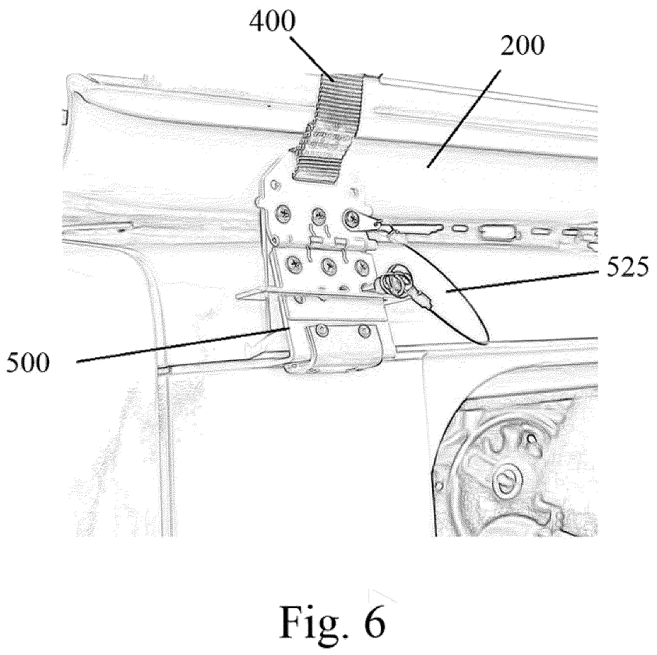

FIG. 6 shows a configuration of the clamp 1 with a locking handle 525. The clamp 1 is attached to the he handle 525 is attached to the top plate 503. When the handle 525 is pushed down it moves the locking plate 510 down into a locking position. When the handle 525 is moved up the locking plate 510 moves up and releases the held item 200.

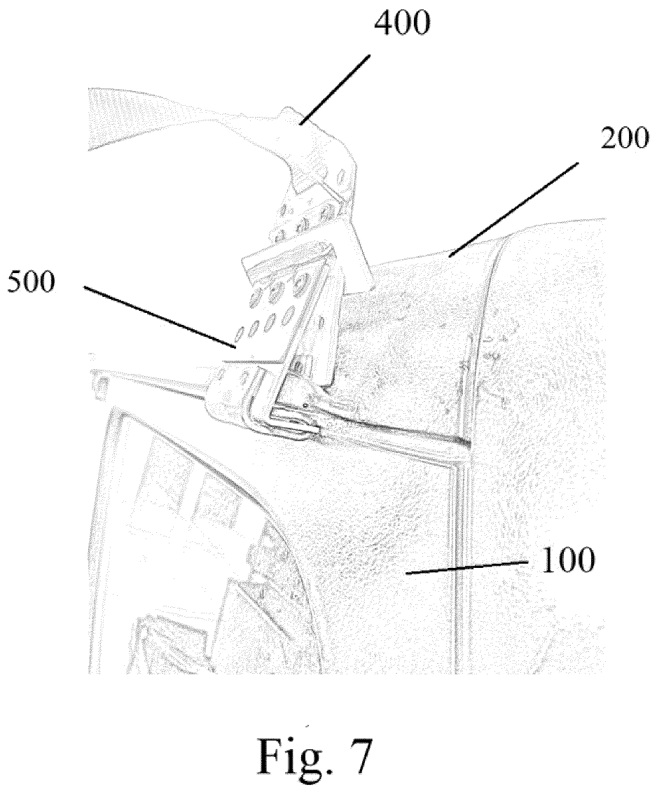

FIG. 7 shows a side view of the clamp 500 attached to the item 200 with a strap 400 attached to the top plate 503. The item 200 is a hardtop on top of a vehicle 100.

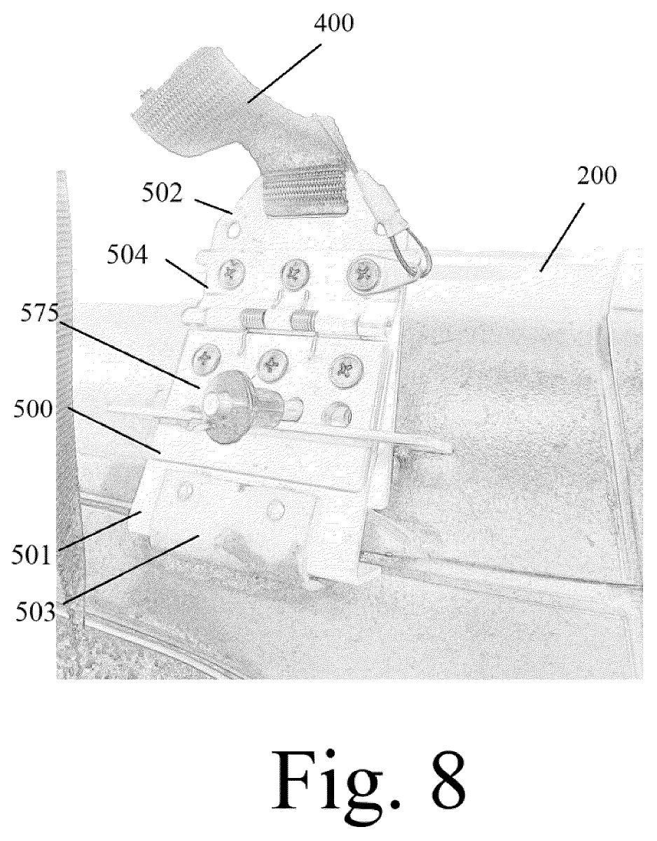

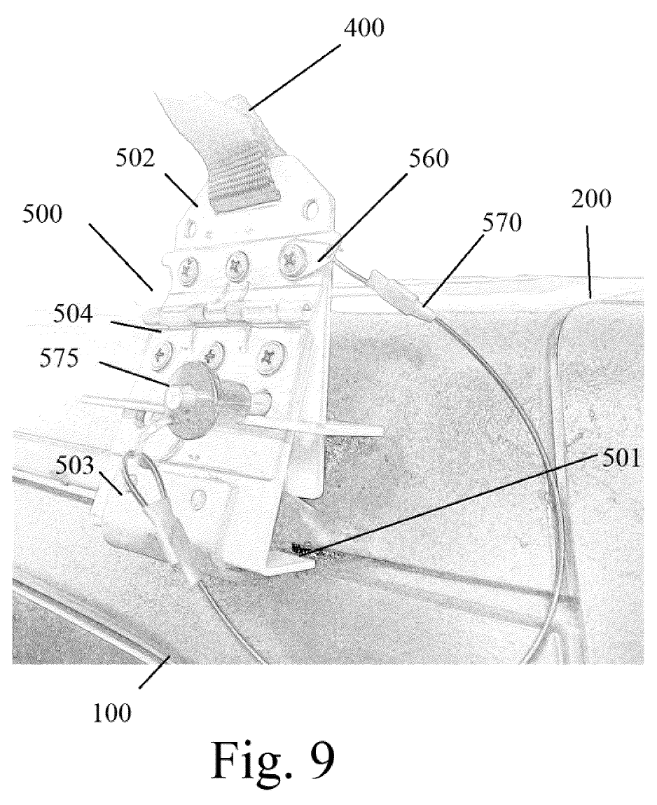

FIGS. 8 and 9 shows an embodiment with a locking pin 575 that is placed into the clamp plate 501 to hold the locking plate 510 in a locked position. In the preferred embodiment, the locking pin 575 has an expanded head and a shaft that goes into a hole in the clamp plate 501. FIG. 9 shows the locking pin 575 secured to the clamp 500 with locking pin cable 570 which is attached to the locking pin 575 and attached to the clamp 500. In one embodiment, the locking pin cable 570 attaches to a bolt of the hinge 504 with a cable eyelet 560.

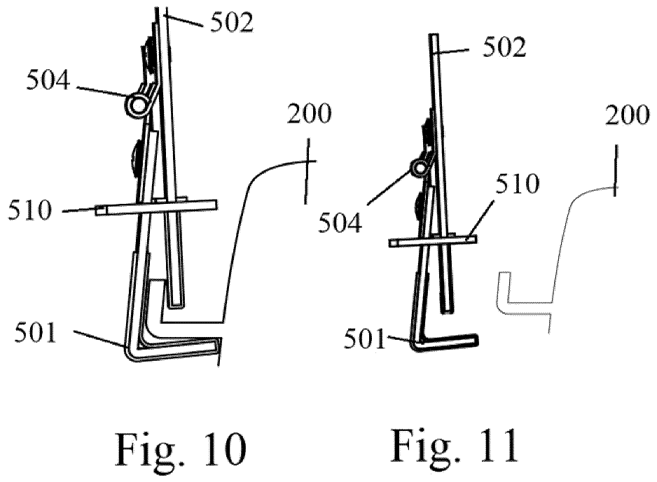

FIG. 10 shows a side view of the clamp 500 attached to the item and FIG. 11 shows the clamp 500 released from the item.

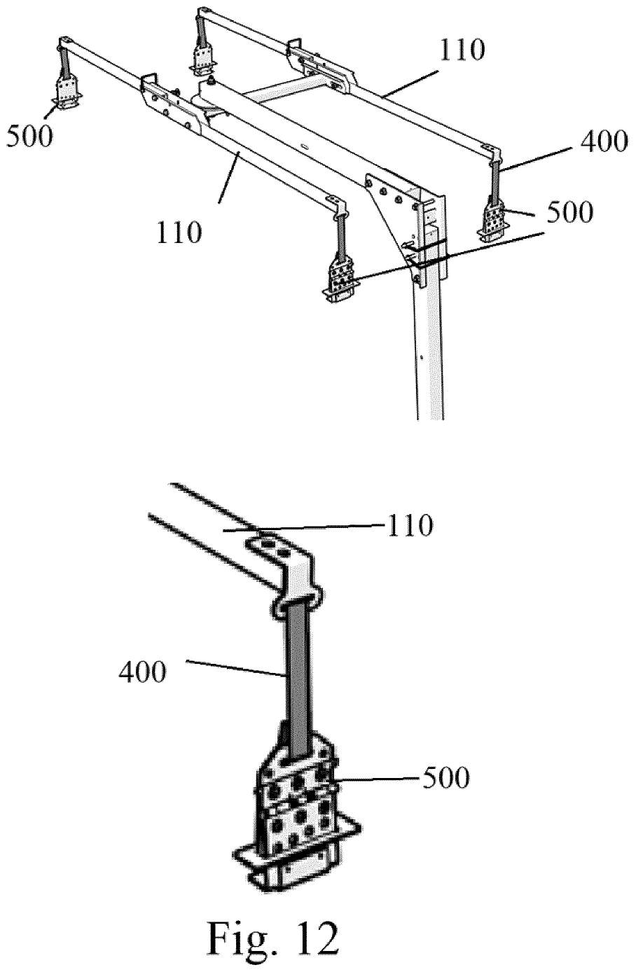

FIG. 12 shows a plurality of clamps 500 hanging down from brackets 110 hanging where the clamps are hanging by straps 400.

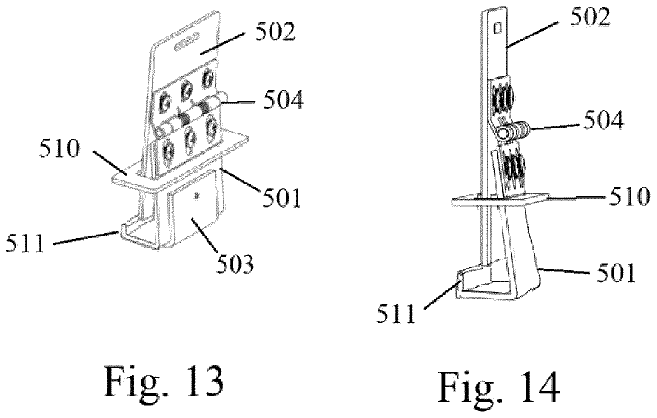

FIGS. 13 and 14 show a hook embodiment of the device 1. In the hook embodiment, the clamp plate 501 has a lip 511 that extends up from the distal end of the pressure surface and can run the width of the clamp plate 501.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a clamp having a top plate, a hinge, a clamp plate and a locking plate.

2. The device according to claim 1 further comprising:
the top plate is a flat rectangular shape having a bottom and a top with a curved bottom that curves behind it.

3. The device according to claim 2 further comprising:
where the top plate has a strap opening at the top.

4. The device according to claim 2 further comprising:
having a strap attached to the top plate.

5. The device according to claim 1 further comprising:
where clamp plate is a flat rectangular shape that bends forward at 90 degrees forming a pressure surface.

6. The device according to claim 5 further comprising:
where the clamp plate has a clamp plate cover.

7. The device according to claim 6 further comprising:
where the clamp plate cover is made of a soft material.

8. The device according to claim 1 further comprising:
having clamp plate and the top plate attached by a hinge.

9. The device according to claim 8 further comprising:
having the hinge connected to the clamp plate and the top plate by one of more of a set of screws or welding or an adhesive.

10. The device according to claim 1 further comprising:
where the locking plate is a flat rectangular shape with an opening in the center of said shape.

11. The device according to claim 1 further comprising:
where the locking plate is pushed down it moves the top plate down and in towards the pressure surface of the clamp plate pivoting on the hinge to hold an item and the locking plate is moved up for release the item.

12. The device according to claim 8 further comprising:
where the locking plate is pushed down it moves the top plate down and in towards the pressure surface of the clamp plate by pivoting on the hinge to hold an item and the locking plate is moved up for release the item.

13. The device according to claim 1 further comprising:
having a handle attached to the top plate.

14. The device according to claim 13 further comprising:
where the handle pushed down it moves the locking plate down the locking plate moves the top plate down and in towards the pressure surface of the clamp plate by pivoting on the hinge to hold an item and the handle is pushed up the locking plate is moved up for release the item.

15. The device according to claim 1 further comprising:
having a locking pin that is placed into the clamp plate to hold the locking plate in a locked position.

16. The device according to claim 15 further comprising:
where the locking pin has an expanded head and a shaft.

17. The device according to claim 15 further comprising:
having where a locking pin cable attached to the locking pin.

18. The device according to claim 5 further comprising:
where the clamp plate has a lip that extends up from the distal end of the pressure surface.

19. A device comprising:
a clamp having a top plate, a hinge, a clamp plate and a locking plate, where the top plate is a flat rectangular shape having a bottom and a top with a curved bottom that curves behind it, where clamp plate is a flat rectangular shape that bends forward at 90 degrees forming a pressure surface, where the clamp plate has a clamp plate cover, where the clamp plate and the top plate attached by a hinge, where the locking plate is a flat rectangular shape with an opening in the center of said shape, where the locking plate is pushed down it moves the top plate down and in towards the pressure surface of the clamp plate pivoting on the hinge to hold an item and the locking plate is moved up for release the item and having a locking pin that is placed into the clamp plate to hold the locking plate in a locked position.

20. A process to clamp an item using the device in claim 19.
